(19) United States
(12) Patent Application Publication
(10) Pub. No.: US 2015/0161822 A1
(43) Pub. Date: Jun. 11, 2015

(54) Location-Specific Digital Artwork Using Augmented Reality

(71) Applicant: Adobe Systems Incorporated, San Jose, CA (US)

(72) Inventor: Sunandini Basu, New Delhi (IN)

(73) Assignee: Adobe Systems Incorporated, San Jose, CA (US)

(21) Appl. No.: 14/102,721

(22) Filed: Dec. 11, 2013

(51) Int. Cl. G06T 19/00; G06F 17/30; G06F 3/0484

(52) U.S. Cl. CPC G06T 19/006; G06F 3/04842; G06F 17/30241

(57) ABSTRACT

Techniques are disclosed for creating, modifying and displaying location-specific digital artwork using augmented reality. A computing device is configured to determine a geographical location. The geographical location can be the current physical location of the device or the location. A database of location-specific information is searched for data representing predefined spatial planes associated with the geographical location. One or more of the spatial planes obtained from the search can be selected by a user via a graphical user interface (GUI). The selected spatial planes form a digital canvas within an interactive drawing interface upon which digital artwork can be created and/or modified. The digital artwork can be rendered via the GUI or other suitable display device, providing a visualization of the digital artwork interposed with the environment at the geographical location. The digital artwork can be exported to a database and associated with the environment.

### FIELD OF THE DISCLOSURE

This disclosure relates to the field of data processing, and more particularly, to techniques for creating, modifying and viewing location-specific digital artwork using augmented reality.

### BACKGROUND

Augmented reality (AR) is a digitally enhanced view of a physical, real-world environment. Generally, AR can be implemented using hardware and software components that project layers of artificial digital information, such as graphics, audio and other sensory enhancements, onto an actual environment or an image of the environment. The information can relate to the overall environment and/or various objects in the environment. Some examples of AR applications include viewing the contents of a package without opening it, virtually drawing the first down line on an American football field, translating text printed on a sign, or rendering the appearance of an unconstructed structure on a piece of property.

### BRIEF DESCRIPTION OF THE DRAWINGS

The accompanying drawings are not intended to be drawn to scale. In the drawings, each identical or nearly identical component that is illustrated in various figures is represented by a like numeral.

FIG. 1 illustrates an example client-server computing system configured in accordance with an embodiment of the present invention.

FIG. 2 is a block diagram representing an example computing device that can be used in conjunction with an embodiment of the present invention.

FIG. 3 illustrates an example methodology for creating, modifying and viewing location-specific digital artwork in an augmented reality environment, in accordance with an embodiment of the present invention.

FIGS. 4-10 depict example screenshot views of a methodology for creating, modifying and viewing location-specific digital artwork using augmented reality, in accordance with an embodiment of the present invention.

### DETAILED DESCRIPTION

As mentioned above, augmented reality can be used to interpose digital information in a real-world environment. However, as will be appreciated in light of this disclosure, present solutions do not provide tools for creating, modifying and viewing digital artwork that is associated with a particular geographical location.

To this end, and in accordance with an embodiment of the present invention, techniques are provided for creating, modifying and viewing location-specific digital artwork using augmented reality. In one specific embodiment, a computing device, such as a smartphone or tablet computer, is configured to determine a geographical location. The geographical location can be the current physical location of the device or the location depicted by an image displayed on the device, including images acquired using a camera integrated into the device and images acquired by other devices. The geographical location can be determined based on coordinates obtained from the Global Positioning System (GPS), other location determination techniques, or both. Other location determination techniques may include, for example, image recognition, metadata associated with an image of a location, and user input. A database of location-specific information, which may be remote to the device and accessible via a communication network, is searched based on the geographical location. The database is searched for data representing one or more spatial planes associated with the environment at the geographical location. The spatial planes are artificial constructs that can, for instance, correspond to objects and/or surfaces (e.g., streets, buildings and/or other structures) at the location. One or more of the spatial planes obtained from the search can be selected by a user via a graphical user interface (GUI) to form a so-called digital canvas within an interactive drawing interface, upon which digital artwork can be created, modified and viewed by the user. The digital artwork can be rendered via the GUI or another suitable display device, providing an AR visualization of the digital artwork at the geographical location from one or more perspectives. The digital artwork can be exported to a database, such that other users can subsequently retrieve and view the artwork at the same location using AR. This can be useful, for instance, to enable multiple people to collaborate on digital artwork created for a particular location. Numerous configurations and variations will be apparent in light of this disclosure.

As used herein, the term “spatial plane,” in addition to its plain and ordinary meaning, includes an imaginary plane associated with a particular geographical location. Such a spatial plane may have an arbitrary, size, boundary and orientation, and may be associated with one or more identifiable elements that physically exist at the location, such as buildings, roads, trees, fences, lawns, signs, or other objects or structures or portions thereof. In one non-limiting example, a spatial plane may be defined to coincide with an external wall of a building at a particular location. In this case, digital artwork may be created, modified and/or viewed on that spatial plane such that, using AR, the digital artwork virtually appears to exist on the wall of the building. Any number of distinct spatial planes may be defined for a given location. Other such examples will be apparent in light of this disclosure.

In one specific embodiment, an example methodology is provided for creating, modifying and viewing digital artwork using augmented reality. The digital artwork can be associated with a specific, real-world location, which may be referenced in any number of ways, such as geographic coordinates (e.g., latitude, longitude and elevation), street address, place name, or any other suitable manner of referencing the location. As the basis for generating the AR environment, one or more photographic images of the physical environment at the location may be obtained using, for example, a camera built into a mobile device. Alternatively, preexisting images of the location can be used so that the user need not be physically present at the location to create, modify or view the artwork. As mentioned above, once the geographical location has been determined, the user can select one or more of the predefined spatial planes associated with that location. The selected spatial planes can be converted into orthographic projections, which form at least a portion of the digital canvas upon which digital artwork can be created, modified and/or viewed using an interactive drawing interface. For example, a spatial plane may coincide with an exterior wall of a building situated at or near the location. Thus, digital artwork created on this particular spatial plane may, using AR, appear as though placed on the wall. The predefined spatial planes may, in some instances, be obtained using Google Maps, Microsoft Photosynth, or another suitable geotagging, mapping, or modeling application. In some embodiments, at least some of the spatial planes are user-definable. The interactive drawing interface may include, for example, Adobe Photoshop®, Adobe Ideas®, or another suitable creative art tool. The artwork created or modified using the interactive drawing interface can be exported to an artwork database, which may be remote to the device (e.g., accessible via a communication network). Any number of users may subsequently access the artwork database to retrieve the digital artwork associated with a particular location. In this manner, multiple users can collaborate on the creation of the artwork, as well as view the work of others.

In some embodiments, digital artwork can be viewed in an AR environment using a mobile computing device having a camera and a display. As the camera images the physical environment, those images are displayed on the display, in some cases in real time. Further, the view of the environment is augmented by digital artwork associated with the location. The view can be updated as the user moves the device with respect to the environment. For example, the device may be configured to recognize a geographical location using an image taken with a built-in camera and/or geo-location techniques, and overlay digital artwork associated with the location on top of the image produced by the camera. The artwork is overlaid in such a manner that it appears to form a portion of the actual environment.

System Architecture

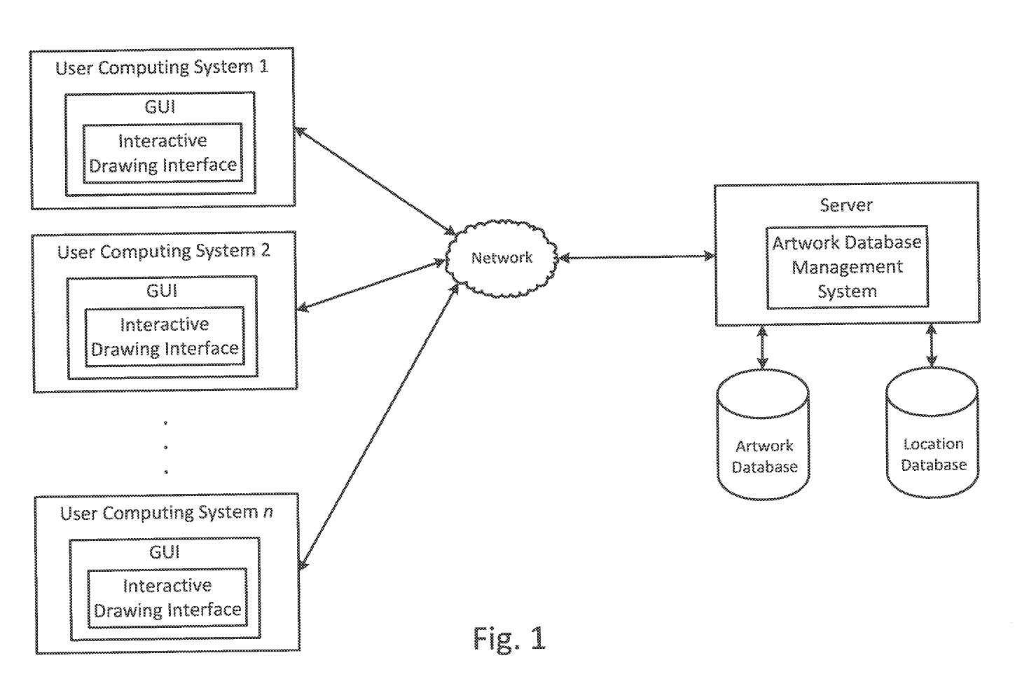

FIG. 1 illustrates an example client-server computing system configured in accordance with an embodiment of the present invention. In this example, one or more user computing systems each include a GUI configured to provide an interactive drawing interface and to interact electronically, via a communication network, with an artwork database management system hosted by a server. Although depicted in FIG. 1 as separate devices, it will be appreciated than in some embodiments the user computing system and the server may be integrated; for example, the artwork database management system may be implemented locally on the user computing system. One or more artwork and location databases operatively connected to the server and the artwork database management system can be configured to store digital artwork, location information and/or other data created and maintained by the artwork database management system. The databases can be implemented, for example, with any suitable type of memory, such as a disk drive included in, or otherwise in communication with, the web server. Other suitable memories include flash memory, random access memory (RAM), a memory stick or thumb drive, USB drive, cloud storage service, etc. In a more general sense, any memory facility can be used to implement the databases.

As will be appreciated in light of this disclosure, the various modules and components of the system shown in FIG. 1, such as the GUI, interactive drawing interface and artwork database management system, can be implemented in software, such as a set of instructions (e.g., C, C++, object-oriented C, JavaScript, Java, BASIC, etc.) encoded on any computer readable medium or computer program product (e.g., hard drive, server, disc, or other suitable non-transient memory or set of memories), that when executed by one or more processors, cause the various methodologies provided herein to be carried out. It will be appreciated that, in some embodiments, various functions performed by the user computing system, the server, and databases, as described herein, can be performed by similar processors and/or databases in different configurations and arrangements, and that the depicted embodiments are not intended to be limiting. Various components of this example embodiment, including the user computing systems and/or server, can be integrated into, for example, one or more desktop or laptop computers, workstations, tablets, smartphones, game consoles, set-top boxes, or other such computing devices. Other componentry and modules typical of a computing system, such as processors (e.g., central processing unit and co-processor, graphics processor, etc.), input devices (e.g., keyboard, mouse, touch pad, touch screen, etc.), and operating system, are not shown but will be readily apparent. The network can be any communications network, such as a user's local area network and/or the Internet, or any other public and/or private communication network (e.g., local and/or wide area network of a company, etc.). The GUI can be implemented using any number of known or proprietary browsers or comparable technology that facilitates retrieving, presenting, and traversing information resources, such as web pages on a website, via a network, such as the Internet.

Example Computing Device

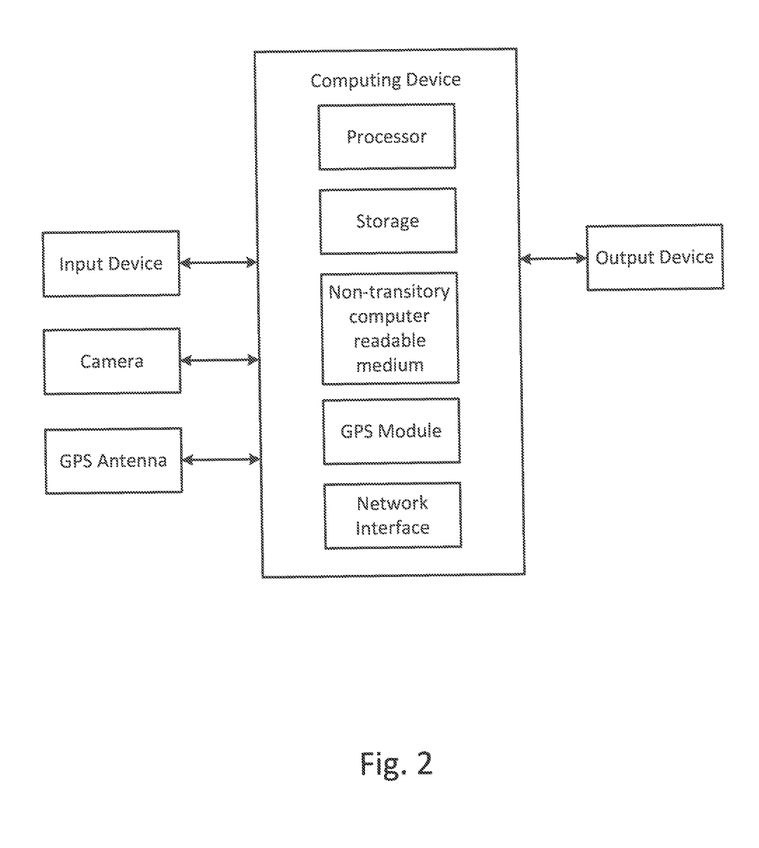

FIG. 2 is a block diagram representing an example computing device that may be used to perform any of the techniques as variously described herein. The computing device may be any computer system, such as a workstation, desktop computer, server, laptop, handheld computer, tablet computer (e.g., the iPad™ tablet computer), mobile computing or communication device (e.g., the iPhone™ mobile communication device, the Android™ mobile communication device, and the like), or other form of computing or telecommunications device that is capable of communication and that has sufficient processor power and memory capacity to perform the operations described herein. A distributed computational system may be provided comprising a plurality of such computing devices.

The computing device includes one or more storage devices and/or non-transitory computer-readable media having encoded thereon one or more computer-executable instructions or software for implementing typical computing device functionality as well as the techniques as variously described herein. The storage devices may include a computer system memory or random access memory, such as a durable disk storage (which may include any suitable optical or magnetic durable storage device, e.g., RAM, ROM, Flash, USB drive, or other semiconductor-based storage medium), a hard-drive, CD-ROM, or other computer readable media, for storing data and computer-readable instructions and/or software that implement various embodiments as taught herein. The storage device may include other types of memory as well, or combinations thereof. The storage device may be provided on the computing device or provided separately or remotely from the computing device. The non-transitory computer-readable media may include, but are not limited to, one or more types of hardware memory, non-transitory tangible media (for example, one or more magnetic storage disks, one or more optical disks, one or more USB flash drives), and the like. The non-transitory computer-readable media included in the computing device may store computer-readable and computer-executable instructions or software for implementing various embodiments. The computer-readable media may be provided on the computing device or provided separately or remotely from the computing device.

The computing device also includes at least one processor for executing computer-readable and computer-executable instructions or software stored in the storage device and/or non-transitory computer-readable media and other programs for controlling system hardware. Virtualization may be employed in the computing device so that infrastructure and resources in the computing device may be shared dynamically. For example, a virtual machine may be provided to handle a process running on multiple processors so that the process appears to be using only one computing resource rather than multiple computing resources. Multiple virtual machines may also be used with one processor.

A user may interact with the computing device through an output device, such as a screen or monitor, which may display one or more user interfaces provided in accordance with some embodiments. The output device may also display other aspects, elements and/or information or data associated with some embodiments. The computing device may include other I/O devices for receiving input from a user, for example, a keyboard or any suitable multi-point touch interface, a pointing device (e.g., a mouse, a user's finger interfacing directly with a display device, etc.). The computing device may include other suitable conventional I/O peripherals. The computing device can include and/or be operatively coupled to various devices such as a camera, GPS antenna, and/or other suitable devices for performing one or more of the functions as variously described herein. The computing device can include a GPS module configured to receive a signal from the GPS antenna and to determine a geographical location based on the signal.

The computing device may include a network interface configured to interface with one or more networks, for example, a Local Area Network (LAN), a Wide Area Network (WAN) or the Internet, through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface may include a built-in network adapter, network interface card, PCMCIA network card, card bus network adapter, wireless network adapter, USB network adapter, modem or any other device suitable for interfacing the computing device to any type of network capable of communication and performing the operations described herein. The network device may include one or more suitable devices for receiving and transmitting communications over the network including, but not limited to, one or more receivers, one or more transmitters, one or more transceivers, one or more antennas, and the like.

The computing device may run any operating system, such as any of the versions of the Microsoft® Windows® operating systems, the different releases of the Unix and Linux operating systems, any version of the MacOS® for Macintosh computers, any version of the iOS® or any version of the Android™ OS for mobile devices, any embedded operating system, any real-time operating system, any open source operating system, any proprietary operating system, any operating systems for mobile computing devices, or any other operating system capable of running on the computing device and performing the operations described herein. In an embodiment, the operating system may be run on one or more cloud machine instances.

In other embodiments, the functional components/modules may be implemented with hardware, such as gate level logic (e.g., FPGA) or a purpose-built semiconductor (e.g., ASIC). Still other embodiments may be implemented with a microcontroller having a number of input/output ports for receiving and outputting data, and a number of embedded routines for carrying out the functionality described herein. In a more general sense, any suitable combination of hardware, software, and firmware can be used, as will be apparent.

Example Methodologies

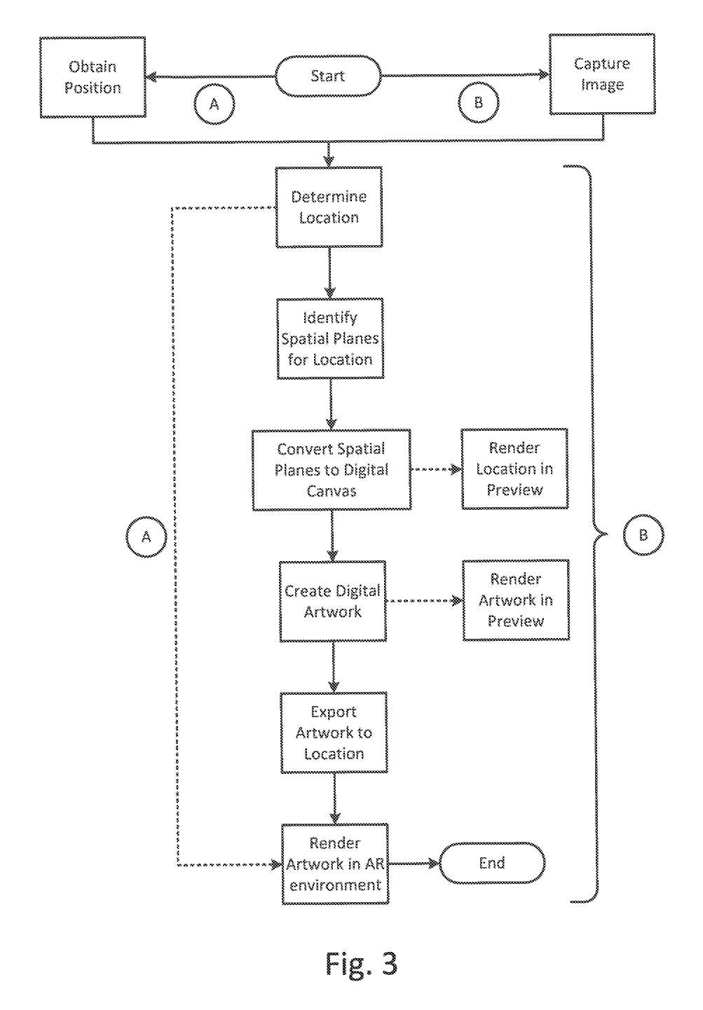

FIG. 3 illustrates an overview of an example methodology for creating, modifying and viewing location-specific digital artwork using augmented reality that may be used in conjunction with various embodiments. In one embodiment, the example methodology is used by the computing device. This example methodology includes two possible workflows: a viewing flow A and a creation flow B. In the viewing flow A, initially a geographical position is obtained. In the creation flow B, initially an image of an environment is captured. Next, the geographical location is determined by a computing device, such as a mobile smartphone, tablet or other suitable device. The geographical location may, for example, be the physical location of the device, the location of one or more objects proximate to the device (e.g., objects within view of a camera coupled to the device), or the location of one or more objects depicted in an image or set of images of the environment at or near the location. In more general terms, the location can be any geographical location. The geographical location can be determined using any number of techniques. In some embodiments, the location can be determined based on geographical (e.g., GPS) coordinates and/or other indicia, such as a user-supplied location, compass heading, altitude, acceleration of the device, Wi-Fi® hotspots, and so forth. In some embodiments, the location can be determined by capturing an image of the physical location with a camera, and processing the image with suitable image recognition software that is configured to identify an object, feature or combination of objects and/or features appearing in the image. In this manner, the location can be correlated with the objects and/or features identified in the image. For example, if the image includes the Statue of Liberty, image recognition software can be used to identify the statue, and therefore, the location (e.g., Liberty Island) of the device or the observer. More specifically, the image recognition software can be used to determine the orientation of the device (e.g., the perspective of the observer) with respect to the statue by analyzing various features of the statue found in the image and calculating relative position accordingly. Other position determination techniques that are suitable for use with various embodiments will be apparent.

Once the geographic location has been determined, the method continues by causing a search to identify one or more spatial planes associated with the location. The spatial planes can be predefined and represented as data stored in a location database, which may be remote to the computing device (e.g., located on a network-accessible server). As mentioned above, the spatial planes can coincide with various objects or elements that physically exist at the location, such as a wall, the side of a building, or a billboard; however, it will be understood that the spatial planes may be arbitrarily defined by a third-party source.

Each spatial plane can be used as a construct for a digital canvas upon which a user can create, modify and/or view digital artwork using a suitable interactive drawing interface. In some embodiments, each spatial plane associated with the location can be represented in a GUI with an outline or other artificial indication so that the user can visualize the presence, position and orientation of such planes. The GUI can be configured to enable the user to select one or more of the planes upon which the user wishes to view, create and/or modify digital artwork. In response to receiving a selection, the selected planes can be presented in the interactive drawing interface as orthographic projections that form at least a portion of the digital canvas, which ordinarily is a two-dimensional surface, such as the flat screen of a smartphone or tablet. In this manner, the planes are conveniently oriented such that they are facing the user, even if the planes would not necessarily face the user while standing at the actual location. It will be understood that orthographic projection is intended as a non-limiting example for forming the digital canvas; that is, the spatial plane(s) need not be oriented in any particular manner within the interactive drawing interface. For instance, one or more of the spatial planes may be presented from the perspective of the observer, which depends on the position of the observer with respect to the environment. In some embodiments, an image of the location and/or digital artwork (existing or new) can be rendered in the GUI separately from the interactive drawing interface, for instance, within a so-called preview pane or other portion of the GUI that is separate from the digital canvas.

The digital canvas and interactive drawing interface can be provided to the user via the GUI. The user may then create and/or modify digital artwork on the digital canvas using the interactive drawing interface. In some instances, the digital canvas may include preexisting digital artwork associated with the location, if any (e.g., artwork created at an earlier time or by another user); in other cases, the digital canvas may initially contain no artwork (e.g., a blank canvas). In any case, the digital artwork can be rendered in the preview pane as it is created and/or modified, providing the user with an AR visualization of the artwork in the environment. Once the user has completed creating or modifying the artwork, the artwork can be exported to an artwork database for storage and future retrieval by the same user or a different user. For example, the artwork can be stored in a database accessible by multiple users. Each user can collaborate on the artwork by accessing the artwork and supplementing it with additional artwork or modifying the existing artwork. In some embodiments, and in both the viewing flow A and the creation flow B, the completed and/or preexisting digital artwork associated with the location can be rendered in the GUI as an AR visualization of the environment at the geographical location using a camera coupled to the device. Furthermore, in some cases, if the user moves the camera with respect to the environment, the rendering of the digital artwork can be updated as the viewpoint or perspective of the camera changes.

Example Implementation

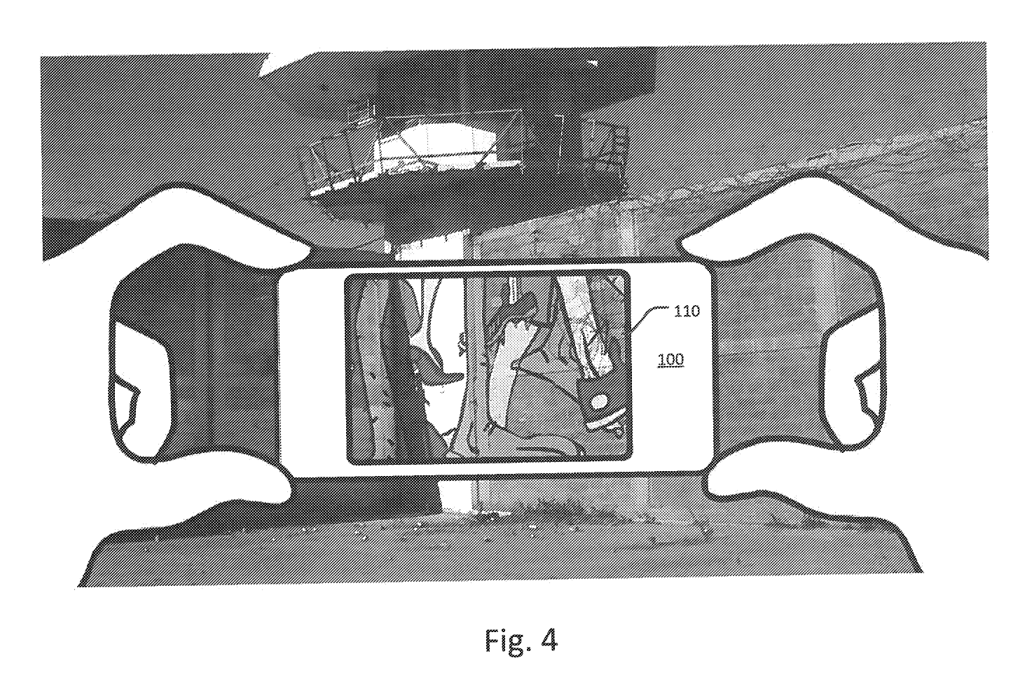

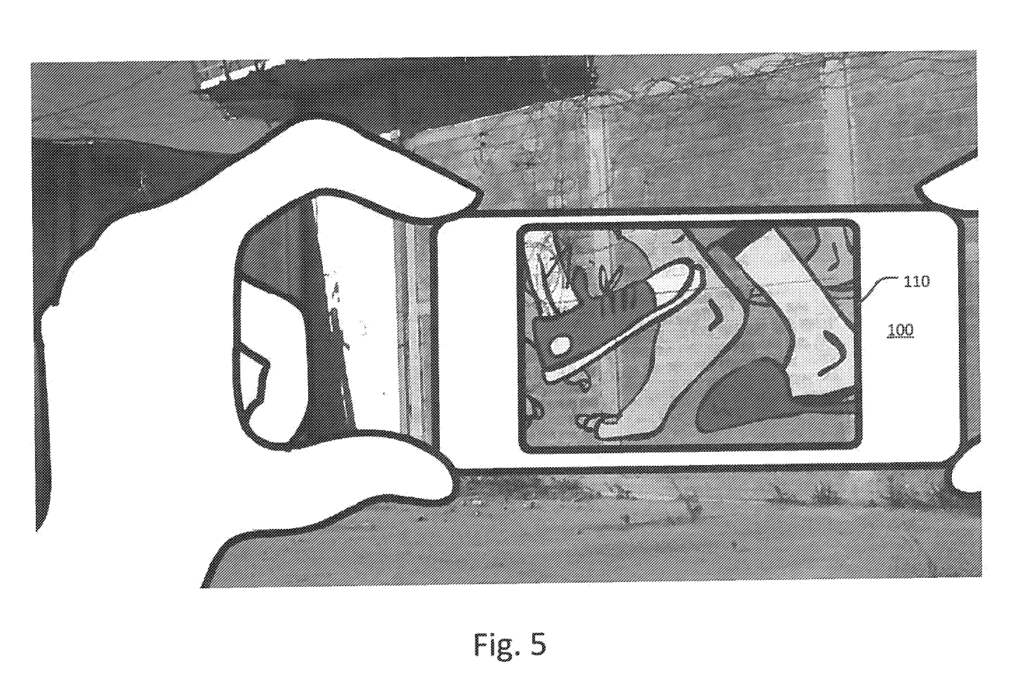

FIGS. 4-10 depict example implementation views of a methodology for creating, modifying and viewing location-specific digital artwork using augmented reality, in accordance with an embodiment. FIG. 4 depicts an example view of an environment at a particular geographical location, and a user holding a representative user computing device 100 (e.g., a mobile smartphone or tablet) having a display 110 for presenting an example GUI. The device 100 includes an integrated camera (not shown) for acquiring an image of a portion of the environment, as displayed on the display 110. Also shown in the display 110 is an AR visualization of example digital artwork associated with the location. In this example, the digital artwork is superimposed over the image of the environment so as to provide the AR visualization of the portion of the location-specific digital artwork that corresponds to the field of view of the camera. The digital artwork can, in some embodiments, be created and/or modified using an interactive drawing interface and/or obtained from an external database based on the location of the device, such as described above with respect to FIG. 3. FIG. 5 depicts another perspective of the same environment after the user has altered the position of the device 100 and thus the field of view of the camera. The changed perspective permits a different portion of the digital artwork associated with the location to be viewed in the display 110.

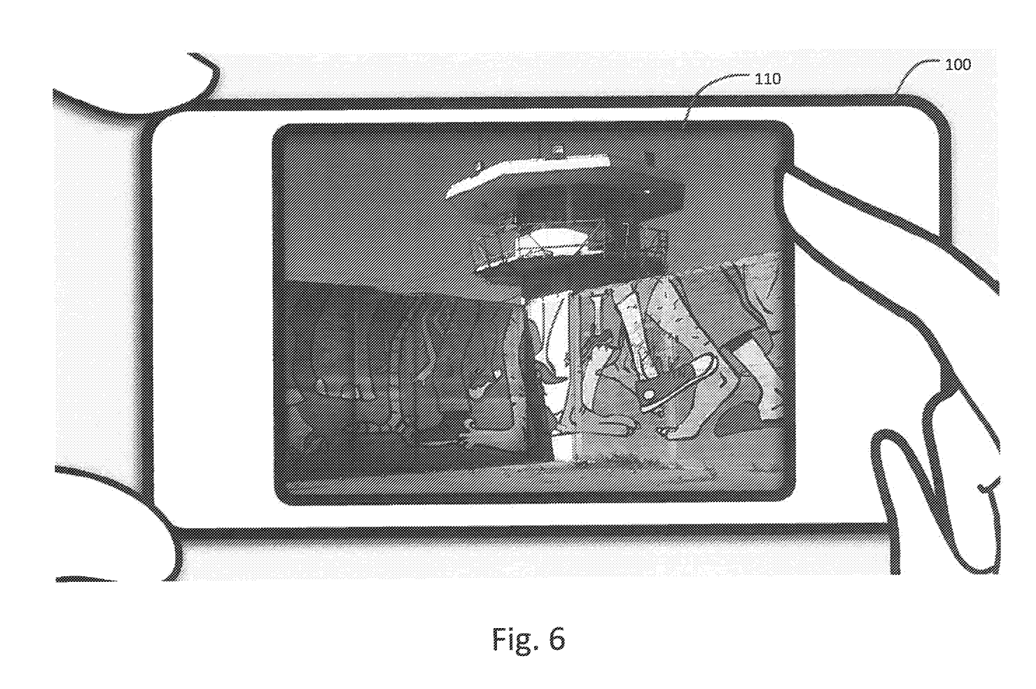

FIG. 6 depicts another example view of the device 100 and display 110, on which a perspective of the environment is shown. The device 100 may include a touch-sensitive screen or other input device. The user can activate the touch-sensitive screen to select the location associated with the environment shown on the display 110. Once selected, the user may begin creating and/or modifying digital artwork associated with the selected location. As discussed above with respect to FIG. 3, the location can be determined based on the geographical coordinates of the device 100, image recognition performed on the image acquired by the camera, and/or other indicia or inputs.

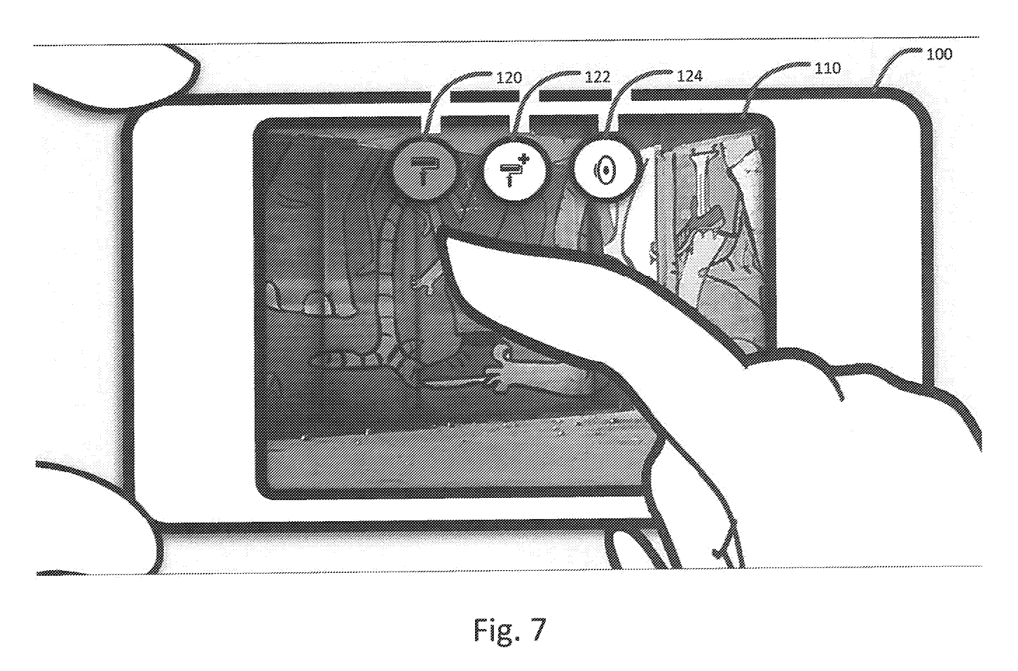

FIG. 7 depicts another example view of the device 100 and display 110, on which the GUI is shown. The GUI can include one or more selectors 120, 122, 124 that enable the user to create, modify or view digital artwork associated with the selected location. By selecting one of the selectors 120, 122, 124, the user can activate the corresponding functions.

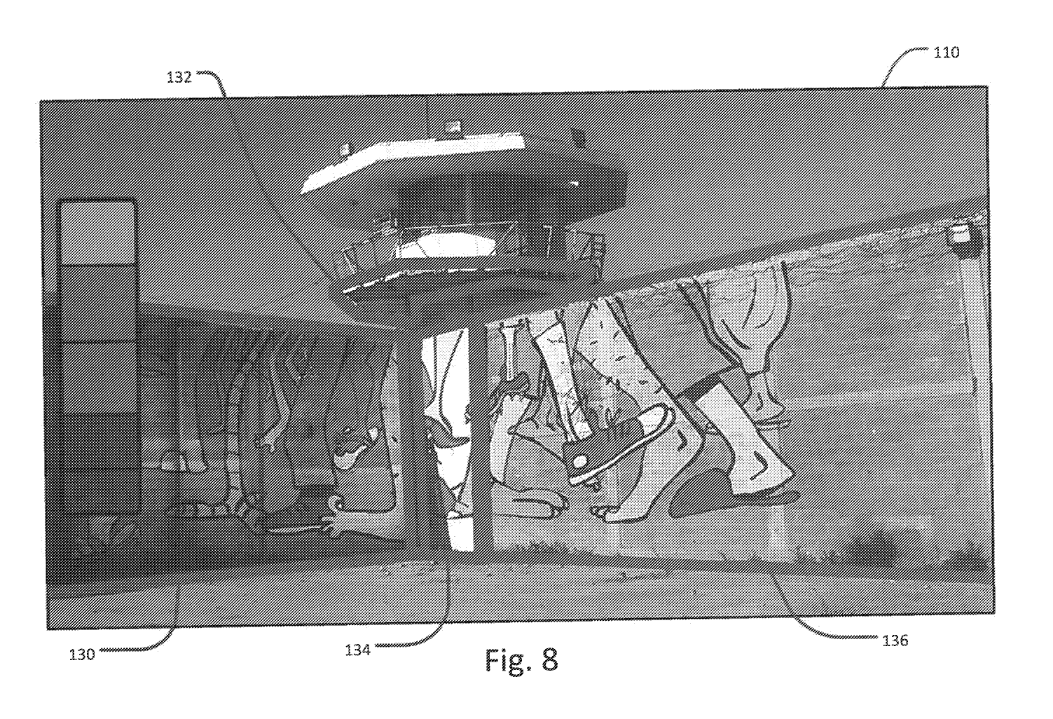

FIG. 8 depicts another example view of the display 110, on which the GUI is shown (for clarity the device 100 is not shown). Once the user has selected the location and a function (e.g., create artwork or modify artwork), a view of the environment is displayed on the screen 110. In the view, the boundaries of several predefined spatial planes 130, 132, 134, 136 associated with the geographical region are shown using solid lines or other suitable indicia. It will be understood that the any number of spatial planes may exist for a given environment. Using the touch-sensitive screen or other input device, the user can select one or more of the spatial planes 130, 132, 134, 136 for creating and/or modifying digital artwork within the respective planes. In this example, presume the user selects planes 130, 132, 134, and 136.

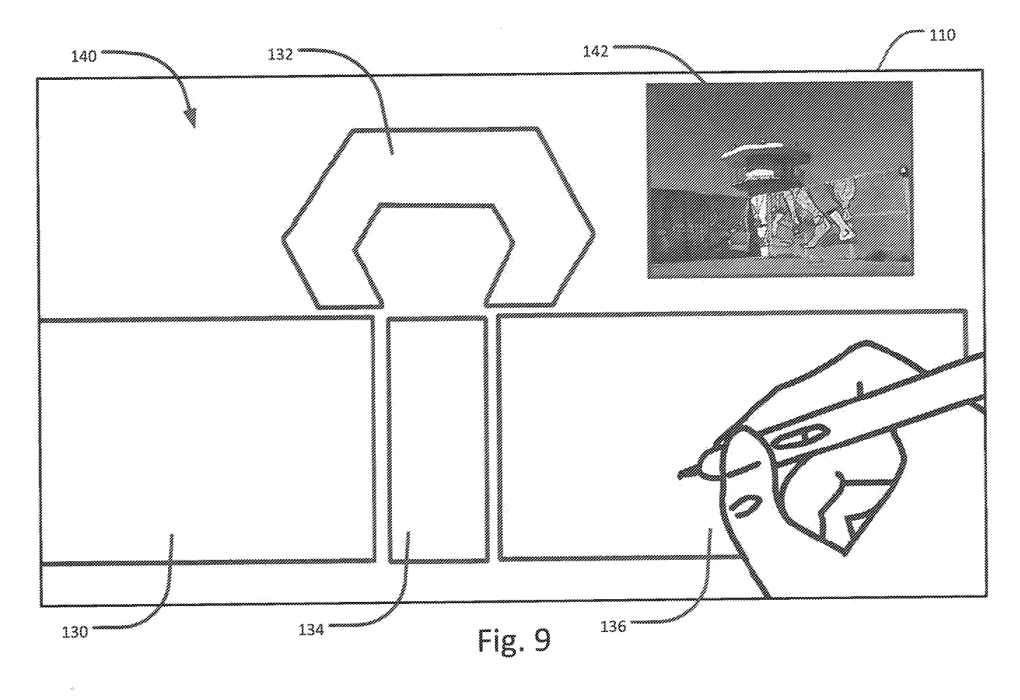

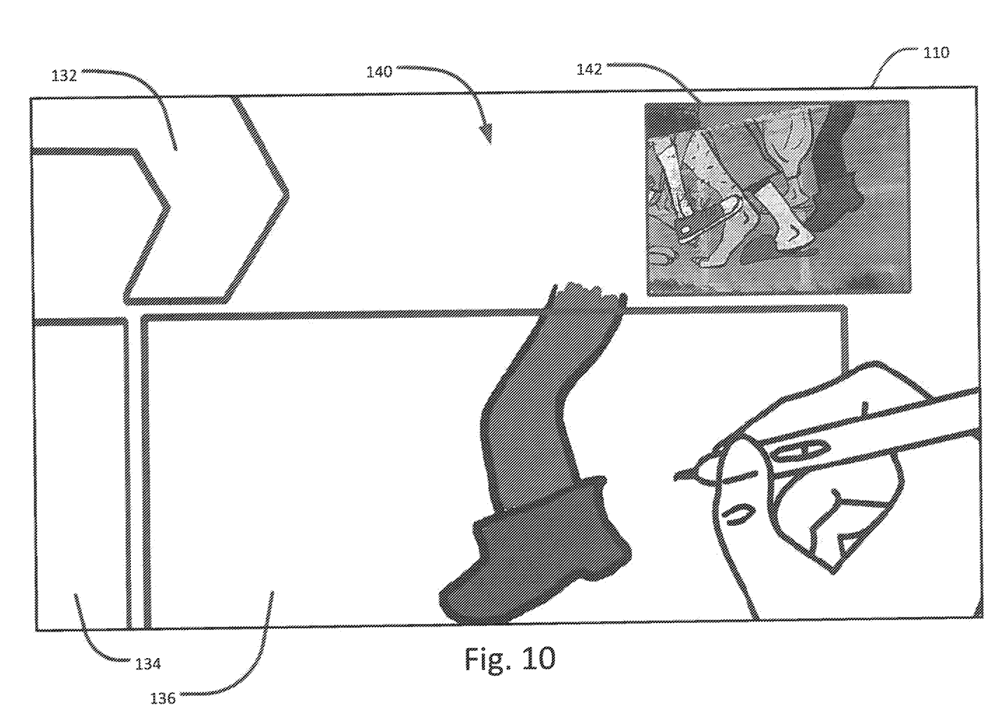

FIG. 9 depicts another example view of the display 110, on which the GUI is shown. In this view, each of the selected planes 130, 132, 134, 136 are shown as orthographic projections, forming a digital canvas 140 upon which the user can create and/or modify digital art using any number of input devices supported by an interactive drawing interface, such as a touch-sensitive screen or any suitable computer-based digital drawing interface. Also shown is a preview pane 142 in which the digital artwork is shown in the AR environment. That is, the digital artwork is displayed in the preview pane as the user creates and modifies the artwork. FIG. 10 depicts another example view of the display 110 as the user creates the digital artwork, showing the artwork on the digital canvas 140 and in the preview pane 142. Once the user has finished working with the digital canvas 140, the artwork can be saved and exported to an external artwork database, such as described above with respect to FIG. 3.

Numerous embodiments will be apparent in light of the present disclosure, and features described herein can be combined in any number of configurations. One example embodiment of the invention provides a computer-implemented method. The method includes determining a geographical location using a device; causing, via a communications network, a search of an external location database to identify data representing predefined spatial planes associated with the geographical location; receiving a selection, via a user interface of the mobile device, of at least one of the predefined spatial planes; providing, via the user interface, an interactive drawing interface for creating, on a digital canvas, digital artwork associated with the selected spatial plane; and rendering the digital artwork on the device. In some cases, the method includes exporting, via the communications network, the digital artwork to an external artwork database. In some cases, the method includes displaying, via the user interface, the digital canvas as an orthographic projection of the selected spatial plane. In some cases, the method includes displaying, via the user interface, preexisting digital artwork associated with the geographical location. In some such cases, the rendering further comprises overlapping the preexisting digital artwork and the digital artwork created on the digital canvas. In some other such cases, the preexisting digital artwork is rendered in a preview pane of the user interface. In some cases, the method includes automatically changing a visual perspective of the digital artwork in response to a change in an orientation of the mobile device. In some cases, the geographical location is determined by the mobile device based at least in part on an electronic photographic image of the geographical location. In some cases, some or all of the functions variously described in this paragraph can be performed in any order and at any time by one or more different processors.

Another example embodiment provides a system including a display, a storage having at least one memory, and one or more processors each operatively coupled to the storage and the display. The one or more processors are configured to carry out a process including generating a user interface via the display; determining a geographical location using a device; causing, via a communications network, a search of an external location database to identify data representing predefined spatial planes associated with the geographical location; receiving a selection, via a user interface of the mobile device, of at least one of the predefined spatial planes; providing, via the user interface, an interactive drawing interface for creating, on a digital canvas, digital artwork associated with the selected spatial plane; and rendering the digital artwork on the device. In some cases, the process includes displaying, via the user interface, the digital canvas as an orthographic projection of the selected spatial plane. In some cases, the process includes displaying, via the user interface, preexisting digital artwork associated with the geographical location. In some such cases, the rendering further comprises overlapping the preexisting digital artwork and the digital artwork created on the digital canvas. In some other such cases, the preexisting digital artwork is rendered in a preview pane of the user interface. In some cases, the process includes automatically changing a visual perspective of the digital artwork in response to a change in an orientation of the device. In some cases, the geographical location is determined by the device based at least in part on an electronic photographic image of the geographical location. Another embodiment provides a non-transient computer-readable medium or computer program product having instructions encoded thereon that when executed by one or more processors cause the one or more processors to perform one or more of the functions defined in the present disclosure, such as the methodologies variously described in this paragraph. As previously discussed, in some cases, some or all of the functions variously described in this paragraph can be performed in any order and at any time by one or more different processors.

The foregoing description and drawings of various embodiments are presented by way of example only. These examples are not intended to be exhaustive or to limit the invention to the precise forms disclosed. Numerous variations will be apparent in light of this disclosure. Alterations, modifications, and variations will readily occur to those skilled in the art and are intended to be within the scope of the invention as set forth in the claims.

What is claimed is:

1. A computer-implemented method comprising:
determining a geographical location using a device;
causing, via a communications network, a search of an external location database to identify data representing predefined spatial planes associated with the geographical location;
receiving a selection, via a user interface of the mobile device, of at least one of the predefined spatial planes;
providing, via the user interface, an interactive drawing interface for creating, on a digital canvas, digital artwork associated with the selected spatial plane; and
rendering the digital artwork on the device.

2. The method of claim 1, further comprising exporting, via the communications network, the digital artwork to an external artwork database.

3. The method of claim 1, further comprising displaying, via the user interface, the digital canvas as an orthographic projection of the selected spatial plane.

4. The method of claim 1, further comprising displaying, via the user interface, preexisting digital artwork associated with the geographical location.

5. The method of claim 4, wherein the rendering further comprises overlapping the preexisting digital artwork and the digital artwork created on the digital canvas.

6. The method of claim 4, wherein the preexisting digital artwork is rendered in a preview pane of the user interface.

7. The method of claim 1, further comprising automatically changing a visual perspective of the digital artwork in response to a change in an orientation of the mobile device.

8. The method of claim 1, wherein the geographical location is determined by the mobile device based at least in part on an electronic photographic image of the geographical location.

9. A computing device, comprising:
a display;
a storage comprising at least one memory; and
one or more processors each operatively coupled to the storage and the display, the one or more processors configured to carry out a process comprising:
generating a user interface via the display;
determining a geographical location using a device;
causing, via a communications network, a search of an external location database to identify data representing predefined spatial planes associated with the geographical location;
receiving a selection, via a user interface of the mobile device, of at least one of the predefined spatial planes;
providing, via the user interface, an interactive drawing interface for creating, on a digital canvas, digital artwork associated with the selected spatial plane; and
rendering the digital artwork on the device.

10. The computing device of claim 9, wherein the process further comprises exporting, via the communications network, the digital artwork to an external artwork database.

11. The computing device of claim 9, wherein the process further comprises displaying, via the user interface, the digital canvas as an orthographic projection of the selected spatial plane.

12. The computing device of claim 9, wherein the process further comprises displaying, via the user interface, preexisting digital artwork associated with the geographical location.

13. The computing device of claim 12, wherein the rendering further comprises overlapping the preexisting digital artwork and the digital artwork created on the digital canvas.

14. The computing device of claim 12, wherein the preexisting digital artwork is rendered in a preview pane of the user interface.

15. The computing device of claim 9, wherein the process further comprises automatically changing a visual perspective of the digital artwork in response to a change in an orientation of the device.

16. The computing device of claim 9, wherein the geographical location is determined by the device based at least in part on an electronic photographic image of the geographical location.

17. A non-transient computer program product having instructions encoded thereon that when executed by one or more processors cause a process to be carried out, the process comprising:
determining a geographical location using a device;
causing, via a communications network, a search of an external location database to identify data representing predefined spatial planes associated with the geographical location;
receiving a selection, via a user interface of the mobile device, of at least one of the predefined spatial planes;
providing, via the user interface, an interactive drawing interface for creating, on a digital canvas, digital artwork associated with the selected spatial plane; and
rendering the digital artwork on the device.

18. The computer program product of claim 17, wherein the process further comprises exporting, via the communications network, the digital artwork to an external artwork database.

19. The computer program product of claim 17, wherein the process further comprises displaying, via the user interface, the digital canvas as an orthographic projection of the selected spatial plane.

20. The computer program product of claim 17, wherein the process further comprises displaying, via the user interface, preexisting digital artwork associated with the geographical location.
